(19) United States
(12) Patent Application Publication
(10) Pub. No.: US 2016/0212616 A1
(43) Pub. Date: Jul. 21, 2016

(54) Secure Transmissions Of Narrowband Digital Signals

(71) Applicant: CommScope Technologies LLC, Hickory, NC (US)

(72) Inventor: Trevor Allen, Sachse, TX (US)

(21) Appl. No.: 14/618,480

(22) Filed: Feb. 10, 2015

Related U.S. Application Data
(60) Provisional application No. 62/105,278, filed on Jan. 20, 2015.

(51) Int. Cl. H04W 12/04; H04L 29/06; H04L 27/22; H04W 52/02; H04L 27/34; H04B 17/318

(52) U.S. Cl. CPC H04W 12/04; H04L 27/3444; H04B 17/318; H04L 27/22; H04W 52/0229; H04L 63/16

(57) ABSTRACT

At one node in a wireless communications network, a transmitter (i) encodes an outgoing data stream as a sequence of outgoing symbols of a symbol constellation, (ii) applies a sequence of random rotations to the outgoing symbols to generate an outgoing sequence of rotated symbols in the same symbol constellation, and (iii) transmits wireless signals based on the rotated symbols. At another network node, a receiver, having knowledge of the sequence of random rotations, (i) recovers an incoming sequence of rotated symbols from the received wireless signals, (ii) applies a corresponding sequence to de-rotations to the recovered rotated symbols to generate a sequence of de-rotated symbols, and (iii) decodes the de-rotated symbols to recover an incoming data stream that is ideally identical to the outgoing data stream. An eavesdropping node in the network that does not have knowledge of the sequence of random rotations is unable to recover meaningful data.

### CROSS-REFERENCE TO RELATED APPLICATIONS

This application claims the benefit of the filing date of U.S. provisional application no. 62/105,278, filed on Jan. 20, 2015 as attorney docket no. 1052.141 PROV, the teachings of which are incorporated herein by reference in their entirety.

### BACKGROUND

1. Field of the Invention

The present invention relates to wireless communications networks and, more specifically but not exclusively, to techniques for providing secure wireless communications.

2. Description of the Related Art

This section introduces aspects that may help facilitate a better understanding of the invention. Accordingly, the statements of this section are to be read in this light and are not to be understood as admissions about what is prior art or what is not prior art.

Ensuring the confidentiality of communications is fundamental to securing any network. This requirement becomes particularly important for wireless systems, where eavesdropping is facilitated by the broadcast nature of the wireless medium. Traditionally, security is viewed as an independent feature addressed above the physical layer, and widely used cryptographic protocols are designed and implemented assuming the physical layer has already been established and provides an error-free link. Such solutions often involve complicated processing capabilities at both the transmitter and the receiver. There are practical scenarios when the application of traditional cryptographic-based methods are not practical because of the limited resources on wireless devices (e.g., limited battery and computation power) and highly dynamic mobile wireless environments (e.g., ad-hoc networks).

### BRIEF DESCRIPTION OF THE DRAWINGS

Other embodiments of the invention will become more fully apparent from the following detailed description, the appended claims, and the accompanying drawings in which like reference numerals identify similar or identical elements.

FIG. 1 shows a block diagram of a portion of a communications network according to one embodiment of the disclosure.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that, in some alternative implementations, the functions/acts noted may occur out of the order noted in the figures. For example, two figures shown in succession may in fact be executed substantially concurrently or may sometimes be executed in the reverse order, depending upon the functionality/acts involved.

This disclosure describes a technique to provide security to two-dimensional symbol-based wireless communications by applying random phase rotations to the symbols prior to transmission. Knowledge of the random sequence of rotations enables an intended recipient to successfully decode the received rotated symbols, while an unknowing eavesdropper will be unable to recover the original data encoded in the received rotated symbols, even in the presence of perfect channel state information (CSI). Moreover, this security is achievable even when the transmitter has no knowledge of the receiver's channel. Knowledge of the random phase rotations provides perfect security for wireless communications between the intended parties.

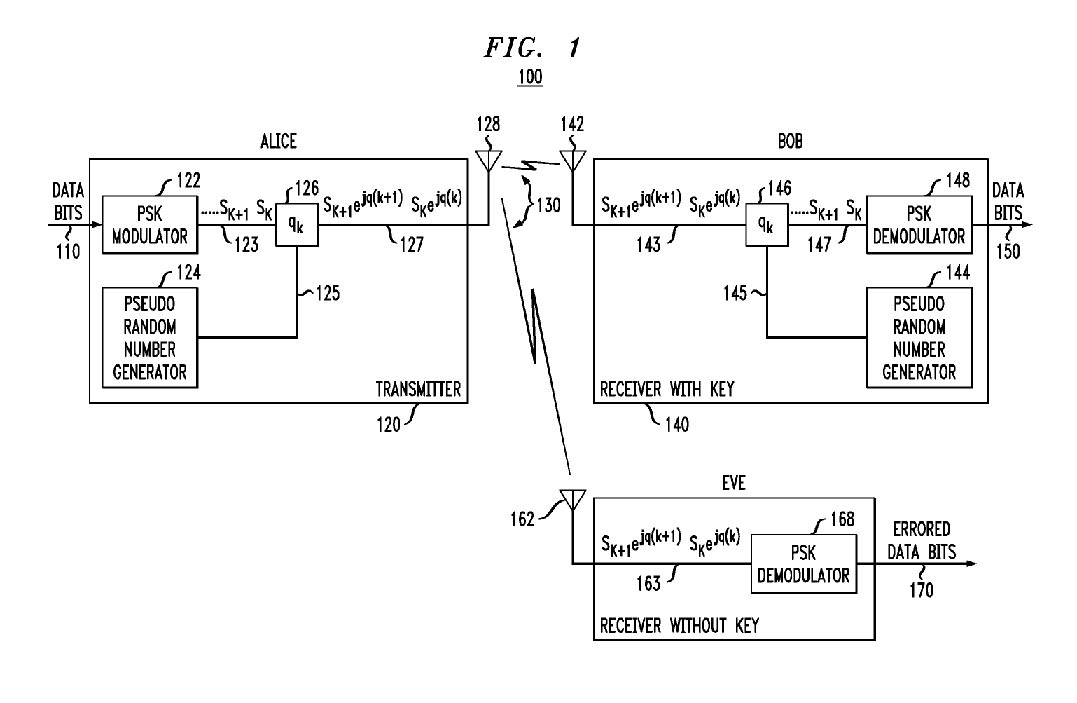

FIG. 1 shows a simplified block diagram of a portion of a communications network 100 according to one embodiment of the disclosure. As shown in FIG. 1, communications network 100 includes users Alice, Bob, and Eve, where Alice transmits secure, encoded signals to intended recipient Bob that unintended recipient (i.e., eavesdropper) Eve cannot successfully decode. Note that, in this disclosure, the terms Alice, Bob, and Eve may be used synonymously with the various communications equipment (e.g., transmitters, receivers, antennas) employed by users Alice, Bob, and Eve.

FIG. 1 includes simplified diagrams showing only some of the elements used to implement Alice's transmitter 120, Bob's receiver 140, and Eve's receiver 160. Those skilled in the art will understand that those components include other signal-processing elements that will depend on the particular implementation. Although not represented in FIG. 1, in a typical implementation, a transmitter of Bob's will also transmit analogous, secure, encoded signals to a receiver of Alice's, where Eve's receiver will also not be able to decode successfully those secure signals.

To achieve the desired secure communications from Alice to Bob, Alice's transmitter 120 applies a sequence of random rotations to constellation-based symbols representing the outgoing data stream 110 that Alice wants to convey to Bob, but not to Eve. Bob's receiver 140, which has knowledge of that same sequence of random rotations, applies corresponding de-rotations to the symbols received from Alice's transmitter to recover successfully Alice's outgoing data stream. Because Eve's receiver 160 does not have knowledge of the sequence of random rotations applied by Alice's transmitter 120, Eve's receiver 160 is unable to successfully recover Alice's outgoing data stream.

As shown in FIG. 1, Alice's transmitter 120 includes a phase-shift keying (PSK) modulator 122 that encodes Alice's outgoing data stream 110 into a sequence of PSK symbols 123 of a corresponding two-dimensional PSK constellation. A phase shifter 126 applies a sequence of random rotations 125, generated by pseudo random number generator 124, to the sequence of PSK symbols 123, on a symbol-by-symbol basis, to generate a sequence of randomly rotated PSK symbols 127, where each rotated PSK symbol is still part of the same PSK constellation. This means that the pseudo random number generator 124 is designed to generate only numbers that correspond to rotations that result in rotated symbols that are also part of the same constellation.

Note that, in some implementations, a random subset of the random rotations 125 correspond to a zero phase shift that leaves the corresponding subset of PSK symbols 123 unchanged. Thus, for example, for a PSK modulation having four constellation points separated from one another by 90-degree rotations, the pseudo random number generator 124 may be designed to generate only the numbers 0, 1, 2, and 3 corresponding to rotations of 0, 90, 180, and 270 degrees, respectively.

In some two-dimensional symbol-based encoding schemes, such quadrature PSK (QPSK), which has a four-symbol constellation, the symbols differ in phase, but have the same amplitude. In other two-dimensional symbol-based encoding schemes, such as 16-QAM (where QAM stands for quadrature amplitude modulation), which has a 16-symbol constellation, the symbols differ in phase or amplitude or both. In 16-QAM, for example, there are four different, four-symbol subsets, where (i) each subset has a different amplitude and (ii) the four equal-amplitude symbols of each subset are separated from each other in phase by 90 degrees. In such schemes, the random symbol modifications of the present disclosure could be applied to only phase such that each symbol can be randomly modified to become any one of only the symbols in its corresponding symbol subset. Thus, for 16-QAM, each symbol can be randomly rotated by 0, 90, 180, or 270 degrees such that the randomly modified symbol is still in the same four-symbol symbol subset as the original, un-rotated symbol.

In other implementations of the present disclosure for such encoding schemes, the random symbol modifications could include one or both of phase and amplitude, such that each symbol can be randomly modified in phase only or in amplitude only or in both phase and amplitude, and the resulting, randomly modified symbol can be any symbol in the entire constellation.

Some communications networks support rate adaption in which the two-dimensional symbol-based encoding scheme can be dynamically changed depending on the quality of the channel. For example, a transmitter and receiver may initiate communications using a lower-rate encoding scheme such as QPSK and then adaptively switch to higher- and higher-rate encoding schemes such as 16-QAM, 32-QAM, or 64-QAM depending on the quality of the channel. For such communications networks, limiting the random symbol modifications to only phase may make implementation simpler, where, for example, random rotations of 0, 90, 180, and 27 degrees will work for all of the available encoding schemes.

Referring again to FIG. 1, the sequence of randomly rotated PSK symbols 127 are then transmitted from Alice's antenna 128 as wireless RF signals 130. Those skilled in the art will understand that, depending on the particular implementation, Alice's transmitter 120 will have other signal-processing elements (e.g., amplifiers, upconverters, digital-to-analog converters, and filters) that are not shown in FIG. 1 and that process and convert the rotated symbols 127 into analog RF signals for transmission from antenna 128 as wireless signals 130.

As shown in FIG. 1, Bob's antenna 142 receives the wireless RF signals 130 transmitted by Alice's antenna 128, and suitable signal-processing elements of Bob's receiver 140 that are not shown in FIG. 1 (e.g., amplifiers, filters, analog-to-digital converters, and downconverters) recover a sequence of PSK symbols 143 that, under normal operations, are identical to Alice's sequence of rotated PSK symbols 127. Bob's receiver 140 also includes a pseudo random number generator 144, which generates a sequence of de-rotations 145 that correspond to the sequence of rotations 125 generated by Alice's pseudo random number generator 124. A phase shifter 146 applies the sequence of de-rotations 145 to the sequence of recovered, rotated PSK symbols 143 to generate a sequence of de-rotated PSK symbols 147 that, under normal operations, are identical to Alice's sequence of original (i.e., un-rotated) PSK symbols 123. The sequence of de-rotated PSK symbols 147 are applied to PSK demodulator 148, which recovers an incoming data stream 150 that, under normal operations, is identical to Alice's outgoing data stream 110.

As shown in FIG. 1, Eve has (i) an antenna 162 that also receives wireless signals 130 and (ii) receiver signal-processing elements (not shown in FIG. 1) that also recover a sequence of received PSK symbols 163 that, under normal operations, are identical to Alice's sequence of rotated PSK symbols 127. However, because Eve does not have a pseudo random number generator that can generate a sequence of de-rotations corresponding to Alice's sequence of random rotations 125, the incoming data stream 170 generated by Eve's demodulator 168 is not identical to, or even close to resembling, Alice's outgoing data stream 110.

To initiate the transmission, Alice and Bob, assuming channel reciprocity, use their received signal strength indicator (RSSI) to exchange a secret key which is used to synchronize the pseudo-random generation of the rotation angles between Alice and Bob. The secret key serves as a seed to the pseudo-random number generators 124 and 144 where the output is masked (e.g., keeping only the log₂(L) most significant bits) to produce an index associated with a rotation angle from the L-PSK signal constellation. Once the generator is seeded, a random rotation angle (125/145) (assuming one of L possible values) is generated every symbol, but the values are only known to the intended parties.

In some implementations, there is a one-to-one correspondence between the sequence of random rotations (e.g., 125) and the sequence of symbols (e.g., 123) such that each rotation is applied to only one symbol. In other implementations, each rotation could be applied to a plurality of consecutive symbols before the next rotation in the sequence is applied. The number of consecutive symbols per rotation could be fixed or it could vary over time, perhaps as a result of another random sequence known to both Alice and Bob.

The proposed scheme provides an effective mechanism for securing communications while not requiring CSI at Alice's transmitter 120. In general, the proposed scheme can be applied to any combination of perfect, imperfect, and no CSI knowledge at Alice and/or Bob, as long as they both have knowledge of the applied rotations.

For the following discussion, we make the following worst-case assumptions that Eve: (1) has perfect CSI, (2) knows the signal constellation being employed, and (3) knows that Alice is using random phase rotations as well as the fact that the rotations change for each symbol. However, Eve does not know the value of the rotation angles from one symbol to the next. Although, Bob and Eve experience, statistically, the same channel (quasi-static Rayleigh fading with AWGN), we also assume that Eve is sufficiently spatially separated from Bob that their channels fade independently.

### Encoding

The transmission is initiated by the exchange of a secret key. In certain embodiments, the secret key can be exchanged using a cross-layer approach (i.e., the key is exchanged using a higher-level protocol) such as Diffie-Hellman or RSA. An exchange based on RSSI is as follows: Alice and Bob each transmit a known signal to each other. Alice initiates the process and Bob responds. This two-way probing is performed over consecutive time slots (a duration of one symbol period is well within the channel coherence time). Ideally, Alice and Bob both should measure the RSSI at the same time. However, they cannot both transmit and receive signals simultaneously. Thus, Alice and Bob measure the radio channel in one direction at a time. However, as long as the time between two directional channel measurements is much smaller than the channel coherence time, they will have the same RSSI estimates. The critical aspect of this process is the reconciliation between Bob and Alice concerning the quantization of the RSSI, which is discussed in S. Premnath, S. Jana, J. Croft, P. Gowda, M. Clark, S. Kasera, N. Patwari, and S. Krishnamurthy, “Secret key extraction from wireless signal strength in real environments,” IEEE Trans. on Mobile Comput., vol.12(5), pp. 917-930, 2013, the teachings of which are incorporated herein by reference.

In all embodiments, it is assumed that a mechanism of sharing a secret key between the intended recipients is available. The secret key is exchanged when the communication session between Alice and Bob is established and remains valid until the session is terminated. Once seeded, the random generation of the parameters θ_{1,k} and θ_{2,k} is known to Alice and Bob but unknown to Eve since her channel experiences independent fading from Bob's channel.

The rotation angles {θₖ} are chosen such that, for any symbol from the original signal constellation, the resulting transmitted signals are also from the same constellation. For example, for L-PSK constellation symbols given by

$$exp \{ \frac{j2 π l}{L} \} ,$$

l=0, . . . , L−1, we select θₖ=2πl′/L where l′=0, . . . , L−1. In this case, the resulting transmitted signals are also L-PSK and, therefore, the peak-to-average ratio (PAR) of the transmitted signal is not increased. Another benefit to the above transmission scheme is that Alice is not required to know Bob's CSI, eliminating the need for CSI feedback to the transmitter. Lastly, it should be noted that this scheme works for any constellation where information is carried in the phase such as L-PSK and M-QAM.

### Decoding

Assuming coherent detection and perfect CSI at the receiver, the received signal can be modeled by Equation (1) as follows:

rₖ=hₖ(sₖe^{iθ}^{ₖ})+nₖ (1)

where {hₖ} are the fading coefficients associated with transmission of the k^{th} symbol, {nₖ} is the additive noise associated with the k^{th} received signal, and {rₖ} represents the k^{th} received signal.

The Rayleigh fading model typically agrees very well with experimental data for mobile systems where no LOS (line of sight) path exists between the transmitter and receiver antennas. For this reason, the channel coefficients are assumed circularly-symmetric, independent identically distributed (IID), complex-valued Gaussian random variables with zero-mean and variance ½ per dimension. The channel coefficients are assumed to be fixed over the channel coherence time which spans multiple symbols. Noise samples are modeled as circularly-symmetric, IID, complex-valued Gaussian random variables with zero-mean and variance N₀/2 per dimension.

### Bob's Detector

As shown in the previous section, Bob's received signal can be modeled by Equation (1) which can be converted to a more convenient form given by Equation (2) as follows:

rₖ=(hₖe^{iθ}^{ₖ})sₖ+nₖ (2)

In Bob's case, the rotation angles are known which means he retains perfect CSI. As such, the maximum likelihood (ML) detector in Bob's PSK demodulator 148 is the matched filter, ŝₖ=(hₖe^{iθ}^{ₖ})*rₖ/∥hₖ∥². From this, we can see that the output of the matched filter can be then passed to an L-PSK slicer in Bob's PSK demodulator 148 to recover the information bits.

### Eve's Detector

Converting the model in Equation (1) to a more convenient form, the signal Eve receives can be modeled by the following Equation (3), where {gᵢ} are the channel coefficients, {ń_{i,k}} is the noise (independent from {hᵢ} and {n_{i,k}}), and {ŕ_{t,k}} represents the k^{th} received signal at timeslot t:

ŕₖ=(gₖe^{iθ}^{ₖ})sₖ+ńₖ (3)

Note that Equation (3) is Eve's statistically equivalent version of Equation (2).

Although Eve is assumed to have perfect receive CSI, being an unintended recipient, she does not know the sequence of random rotations {θₖ} (125 in FIG. 1). However, she may know the L possible values of those rotations {θₖ}. Knowing that the rotation {θₖ} changes every symbol removes blind equalization as an option for Eve.

Notice in Equation (3), that the rotation angles effectively add a phase shift to the already known channel coefficient. This leads to the realization that, even with perfect CSI, the addition of the unknown phase rotations results in Eve having a partially coherent detector (meaning that she knows the magnitude of the channel coefficients, but she does not know the phase), so she no longer has perfect CSI, but only “partial” CSI.

Given that the symbol ŕₖ is received, Eve's best guess as to what symbol, sₖ, was sent is the symbol \tilde{s}ₖ that maximizes the likelihood function, since this will minimize the probability of errors. The likelihood function of the received signal ŕₖ is conditioned on the knowledge of \tilde{θ} (the estimate for the rotation angle) and g (the known channel coefficients) and is given by the following equation:

$$f ( {{r}^{′}}_{k} \vert {\tilde{s}}_{k} , \tilde{θ} , g ) ∝ exp ( \frac{- 1}{2 {σ}^{2}} {‖ {{r}^{′}}_{k} - ( {g}_{k} {e}^{i {\tilde{ θ}}_{k}} ) {\tilde{s}}_{k} ‖}^{2} )$$

Maximizing f(ŕₖ|\tilde{s}ₖ, \tilde{θ}, g) reduces to minimizing the argument in the complex exponential, which is the squared Euclidean distance ∥ŕₖ−(gₖe^{i\tilde{θ}}^{ₖ})\tilde{s}ₖ∥². Therefore, the ML decoding metric reduces to Equation (4) as follows:

$$\{ {\hat{s}}_{k} , {\hat{θ}}_{k} \} = arg {min}_{{\tilde{s}}_{k} , {\tilde{θ}}_{k}} {‖ {{r}^{′}}_{k} - ( {g}_{k} {e}^{i {\tilde{ θ}}_{k}} ) {\tilde{s}}_{k} ‖}^{2} . \qquad ( 4 )$$

In other words, the best guess Eve's decoder can make is to calculate ∥ŕₖ−(gₖe^{i\tilde{θ}}^{ₖ})\tilde{s}ₖ∥² for every possible combinations of {\tilde{s}ₖ, \tilde{θ}} that could have been sent, and pick the one, {ŝₖ, \hat{θ}ₖ}, that yields the smallest metric value. This is referred to as an exhaustive search, and its complexity is exponential in terms of the number of symbols in the codeword. For example, if Alice transmits one symbol and the underlying constellation is QPSK (quadrature PSK), then ∥ŕₖ−(gₖe^{i\tilde{θ}}^{ₖ})\tilde{s}ₖ∥² must be calculated over L² pairs of information symbols. Computing this ML estimate involves an exhaustive search over the L² pairs of information symbols together with the rotation angle pairs resulting in O(L²) search complexity which becomes formidable as L increases. To reduce this complexity, Eve can first compute the ML estimate of \tilde{s}ₖ conditioned on the rotation angle {θₖ} given by the following form:

(\tilde{s}ₖ|\tilde{θ}ₖ)_{ML}=(gₖe^{i\tilde{θ}}^{ₖ})*rₖ∥gₖ∥²

Since Eve has a priori knowledge of Alice's transmission scheme, Eve can employ a “conditional maximum likelihood (ML) detector” where Eve conditions on L values of {θₖ} to create matched filters. This results in L simultaneous matched filters (based on the L possible values of θₖ). The normalized output of each matched filter is an estimate of the transmitted symbol, \tilde{s}ₖ. Using the normalized output, the detector then selects the symbol \tilde{s}ₖ closest to ŝₖ in Euclidean distance which is then passed to an L-PSK slicer. It should be noted that Eve cannot estimate \tilde{s}ₖ without estimating \tilde{θ}ₖ and therefore the conditional ML detector is actually obtaining the ML estimate for both \tilde{s}ₖ and \tilde{θ}ₖ. This is important because, if Eve is unable to properly estimate \tilde{θ}ₖ, then she will not be able to estimate \tilde{s}ₖ either.

Conceptually, we can see from Equation (3) that the rotation angles effectively apply a phase shift to the assumed known channel coefficients in Eve's ML detector. As a result, even with perfect CSI, the addition of the unknown random phase rotations results in Eve having a partially-coherent ML detector which severely degrades her ability to extract the information carried in the phase of the signal.

### Remarks

To exchange a secret key based on RSSI, Alice and Bob can perform a two-way probing over consecutive time slots. As long as the channel is fixed over these two time slots, then, due to channel reciprocity, Alice and Bob both measure the same RSSI. Eve listens to both transmissions, but due to her spatial separation from Bob, her RSSI is independent of Alice's and Bob's RSSI. The RSSI quantizer design and the length of the secret key are design trade-offs. Increasing the number of probes used in the construction of the secret key would incur additional overhead while providing additional security. Furthermore, the rate at which secret bits can be extracted from the channel is fundamentally limited by the channel coherence time. In highly dynamic environments, the reduced channel coherence time will decrease the rate at which secret bits can be extracted by Alice and Bob from the channel, but is mitigated by that fact that the key is exchanged only once at the beginning of the communication session.

For M-QAM constellations, the rotation angles take on the values θ={0, π/2, π, 3π/2} to avoid increasing the PAR.

The number of possible phase rotations grows with the square of the signal constellation size. However, because the phase rotations associated with BPSK, i.e., θ={0, π}, are common to all other L-PSK constellations, they provide a minimal set of random phase rotations that can be used to simplify Bob's RSSI quantization to two levels only.

This disclosure describes a secure transmission technique using random phase rotations added to the transmitted symbols. This technique has been applied to L-PSK but can be applied to any constellation where information is carried in the signal's phase. The added rotations de-correlate an unintended receiver's CSI, resulting in perfect secrecy for the intended recipients without the need for CSI feedback to the transmitter.

In certain embodiments, a communications system comprises a transmitter and a receiver. The transmitter (i) converts an outgoing data stream into an outgoing sequence of symbols corresponding to a signal constellation, (ii) applies a sequence of random rotations to the outgoing sequence of symbols to generate an outgoing sequence of randomly rotated symbols, and (iii) transmits outgoing signals based on the outgoing sequence of randomly rotated symbols.

The receiver (i) receives incoming signals based on the outgoing signals, (ii) recovers an incoming sequence of randomly rotated symbols from the incoming signals, (iii) applies de-rotations, based on the sequence of random rotations, to the incoming sequence of randomly rotated symbols to generate an incoming sequence of de-rotated symbols, and (iv) recovers an incoming data stream from the incoming sequence of de-rotated symbols.

In certain embodiments, the transmitter transmits the outgoing signals using only a single transmit antenna.

In certain embodiments, the transmitter further comprises (i) a modulator that converts the outgoing data stream into the outgoing sequence of symbols corresponding to the signal constellation; (ii) a random number generator that generates a sequence of random numbers; and (iii) a symbol rotator that applies the sequence of random rotations to the outgoing sequence of symbols to generate the outgoing sequence of randomly rotated symbols, wherein the sequence of random rotations are based on the sequence of random numbers. The single transmit antenna transmits the outgoing signals based on the outgoing sequence of randomly rotated symbols.

In certain embodiments, the receiver receives the incoming signals using only a single receive antenna.

In certain embodiments, the receiver further comprises (i) front-end circuitry that recovers the incoming sequence of randomly rotated symbols from the incoming signals; (ii) a random number generator that generates a sequence of random numbers; (iii) a symbol de-rotator that applies the de-rotations, based on the sequence of random numbers, to the incoming sequence of randomly rotated symbols to generate the incoming sequence of de-rotated symbols; and (iv) a demodulator that recovers the incoming data stream from the incoming sequence of de-rotated symbols.

In certain embodiments, the transmitted outgoing signals are single-carrier signals.

In certain embodiments, the symbol constellation has more than two symbols, and each symbol in the outgoing sequence of symbols can be rotated to any one of more than two different symbols in the constellation.

Embodiments of the invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, general-purpose computer, or other processor.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The functions of the various elements shown in the figures, including any functional blocks, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of certain terms should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A communications network comprising:
a transmitter that (i) converts an outgoing data stream into an outgoing sequence of symbols corresponding to a symbol constellation, (ii) applies a sequence of random rotations to the outgoing sequence of symbols to generate an outgoing sequence of rotated symbols, and (iii) transmits outgoing signals based on the outgoing sequence of rotated symbols; and
a receiver that (i) receives incoming signals based on the transmitted outgoing signals, (ii) recovers an incoming sequence of rotated symbols from the incoming signals, (iii) applies a sequence of de-rotations based on the sequence of random rotations to the incoming sequence of rotated symbols to generate an incoming sequence of de-rotated symbols, and (iv) recovers an incoming data stream from the incoming sequence of de-rotated symbols.

2. The communications network of claim 1, wherein the transmitter comprises a transmit antenna.

3. The communications network of claim 2, wherein the transmitter transmits the outgoing signals using only a single transmit antenna.

4. The communications network of claim 1, wherein the transmitter comprises:
a modulator that converts the outgoing data stream into the outgoing sequence of symbols corresponding to the symbol constellation;
a random number generator that generates a sequence of random numbers; and
a symbol rotator that applies the sequence of random rotations to the outgoing sequence of symbols to generate the outgoing sequence of rotated symbols, wherein the sequence of random rotations are based on the sequence of random numbers.

5. The communications network of claim 4, wherein the random number generator generates the sequence of random numbers using a seed value based on a received signal strength indicator (RSSI) value measured by the transmitter.

6. The communications network of claim 4, wherein the modulator is an L-symbol phase-shift keying (L-PSK) modulator or an M-symbol quadrature amplitude modulation (M-QAM) modulator.

7. The communications network of claim 1, wherein the receiver comprises a receive antenna.

8. The communications network of claim 7, wherein the receiver receives the incoming signals using only a single receive antenna.

9. The communications network of claim 1, wherein the receiver comprises:
a random number generator that generates a sequence of random numbers;
a symbol de-rotator that applies the sequence of de-rotations, based on the sequence of random numbers, to the incoming sequence of rotated symbols to generate the incoming sequence of de-rotated symbols; and
a demodulator that recovers the incoming data stream from the incoming sequence of de-rotated symbols.

10. The communications network of claim 9, wherein the random number generator generates the sequence of random numbers using a seed value based on an RSSI value measured by the receiver.

11. The communications network of claim 9, wherein the demodulator is a PSK demodulator.

12. The communications network of claim 1, wherein the transmitted outgoing signals are single-carrier signals.

13. The communications network of claim 1, wherein:
the symbol constellation has more than two symbols; and
each symbol in the outgoing sequence of symbols can be rotated to any one of more than two different symbols in the constellation.

14. The invention of claim 1, wherein:
the transmitter transmits the outgoing signals using only a single transmit antenna;
the transmitter comprises:
a modulator that converts the outgoing data stream into the outgoing sequence of symbols corresponding to the symbol constellation, wherein the modulator is an L-PSK modulator or an M-QAM modulator;
a random number generator that generates a sequence of random numbers using a seed value based on an RSSI value measured by the transmitter; and
a symbol rotator that applies the sequence of random rotations to the outgoing sequence of symbols to generate the outgoing sequence of rotated symbols, wherein the sequence of random rotations are based on the sequence of random numbers;
the receiver receives the incoming signals using only a single receive antenna;
the receiver comprises:
a random number generator that generates a sequence of random numbers using a seed value based on an RSSI value measured by the receiver;
a symbol de-rotator that applies the sequence of de-rotations, based on the sequence of random numbers, to the incoming sequence of rotated symbols to generate the incoming sequence of de-rotated symbols; and
a demodulator that recovers the incoming data stream from the incoming sequence of de-rotated symbols;
the transmitted outgoing signals are single-carrier signals;
the symbol constellation has more than two symbols; and
each symbol in the outgoing sequence of symbols can be rotated to any one of more than two different symbols in the constellation.

15. The transmitter of the communications network of claim 1.

16. The transmitter of the communications network of claim 14.

17. The receiver of the communications network of claim 1.

18. The receiver of the communications network of claim 14.
